(19) United States
(12) Patent Application Publication
(10) Pub. No.: US 2025/0214408 A1
(43) Pub. Date: Jul. 3, 2025

(54) MOUNTING STRUCTURE FOR ELECTRICAL DEVICE

(71) Applicant: TOYOTA JIDOSHA KABUSHIKI KAISHA, Toyota-shi (JP)

(72) Inventor: Noriyuki YAMANAKA, Nagoya-shi (JP)

(73) Assignee: TOYOTA JIDOSHA KABUSHIKI KAISHA, Toyota-shi (JP)

(21) Appl. No.: 18/901,472

(22) Filed: Sep. 30, 2024

(30) Foreign Application Priority Data
Dec. 29, 2023 (JP) 2023-223762

(51) Int. Cl. B60K 1/02

(52) U.S. Cl. CPC B60K 1/02

(57) ABSTRACT

A mounting structure for an electrical device of the present disclosure is for attaching an electrical device to a target device that is a source of vibration, and includes: a first support member that is fastened to one end face of the electrical device in the longitudinal direction via a plurality of first bushes and a plurality of first bolts, and is fixed to the target device; a second support member that is fastened to one of a pair of side surfaces of the electrical device extending in the longitudinal direction from the one end face via a second bush and a second bolt, and is fixed to the target device; and a third support member that is fastened to the other of the pair of side surfaces of the electrical device via a third bush and a third bolt, and is fixed to the target device.

### CROSS-REFERENCE TO RELATED APPLICATION

This application claims priority to Japanese Patent Application No. 2023-223762 filed on Dec. 29, 2023, incorporated herein by reference in its entirety.

### BACKGROUND

### 1. Technical Field

The present disclosure relates to mounting structures for electrical devices for mounting an electrical device to a target device.

### 2. Description of Related Art

Conventionally, a battery electric vehicle including a rear motor for driving rear wheels and a power control unit for supplying alternating current power to the rear motor has been known in the art (see, for example, Japanese Unexamined Patent Application Publication No. 2018-70041 (JP 2018-70041 A)). The power control unit of this battery electric vehicle is housed in a case. The case includes a front rib extending from a front surface of the case, and right and left rear ribs extending from a rear surface of the case. Each of the front rib, right rear rib, and left rear rib of the case is fixed to a rear floor panel of the battery electric vehicle via an anti-vibration bush press-fitted through a through hole in the rib and a bolt extending through a hollow portion of the anti-vibration bush in the up-down direction (height direction).

### SUMMARY

In this conventional battery electric vehicle, the anti-vibration bushes can protect the power control unit that is an electrical device from loads such as vibration generated in the battery electric vehicle. In this battery electric vehicle, however, the resonance magnification of the anti-vibration bushes may increase in a specific frequency range, and vibration of the power control unit may increase.

A primary object of the present disclosure is to provide a mounting structure for an electrical device that can satisfactorily reduce vibration of the electrical device attached to a target device that is a source of vibration.

A mounting structure for an electrical device according to the present disclosure is configured to mount the electrical device to a target device that is a source of vibration. The mounting structure includes:
a first support member that is fastened to one end face in a longitudinal direction of the electrical device via a plurality of first bushes and a plurality of first bolts and that is fixed to the target device;
a second support member that is fastened to one of a pair of side surfaces of the electrical device via a second bush and a second bolt and that is fixed to the target device, the side surfaces being surfaces extending in the longitudinal direction from the one end face; and a third support member that is fastened to another of the side surfaces of the electrical device via a third bush and a third bolt and that is fixed to the target device.

The mounting structure for the electrical device of the present disclosure includes the first support member, the second support member, and the third support member. The first support member is fastened to the one end face in the longitudinal direction of the electrical device via the first bushes and the first bolts, and is fixed to the target device. The second support member is fastened to the one of the side surfaces of the electrical device via the second bush and the second bolt, and is fixed to the target device, and the side surfaces are surfaces extending in the longitudinal direction from the one end face. The third support member is fastened to the other of the side surfaces of the electrical device via the third bush and the third bolt, and is fixed to the target device. This configuration allows a contraction direction of the first bush and a contraction direction of the second and third bushes to cross each other. Therefore, the resonance magnification of the first, second and third anti-vibration bushes is less likely to increase in a specific frequency range. As a result, the mounting structure for the electrical device of the present disclosure can satisfactorily reduce vibration of the electrical device attached to the target device that is a source of vibration.

The second support member may be fastened to the one of the side surfaces via the second bush and the second bolt, the second bush being a single second bush, and the second bolt being a single second bolt.

The third support member may be fastened to the other of the side surfaces via the third bush and the third bolt, the third bush being a single third bush, and the third bolt being a single third bolt.

The second and third support members may be connected to each other.

With this configuration, the second and third support members restrain each other. Therefore, movement of the second and third support members due to vibration of the target device can be restricted, so that loosening of the second and third bolts can be satisfactorily reduced.

The second support member may be fastened to the one of the side surfaces via a plurality of the second bushes and a plurality of the second bolts. The third support member may be fastened to the other of the side surfaces via a plurality of the third bushes and a plurality of the third bolts.

In this mounting structure, when the target device vibrates, movement of the second support member with respect to the electrical device can be restricted by the second bolts, and movement of the third support member with respect to the electrical device can be restricted by the third bolts. Therefore, loosening of the second and third bolts can be satisfactorily reduced even when the second and third support members are not connected to each other.

The target device may be either a transaxle mounted on a vehicle and including at least an electric motor or a different device attached to the transaxle. The electrical device may be a charger that is used to charge a battery configured to transfer electric power to and from the electric motor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a vehicle to which a mounting structure for an electrical device of the present disclosure is applied;

FIG. 2 is a schematic configuration diagram showing a transaxle mounted on vehicles shown in FIG. 1;

FIG. 3 is a perspective view for explaining a mounting structure for an electrical device of the present disclosure;

FIG. 4 is a perspective view for explaining a mounting structure for an electrical device according to the present disclosure; and

FIG. 5 is a schematic diagram for explaining another mounting structure for an electrical device of the present disclosure.

### DETAILED DESCRIPTION OF EMBODIMENTS

Embodiments of the present disclosure will now be described with reference to the drawings.

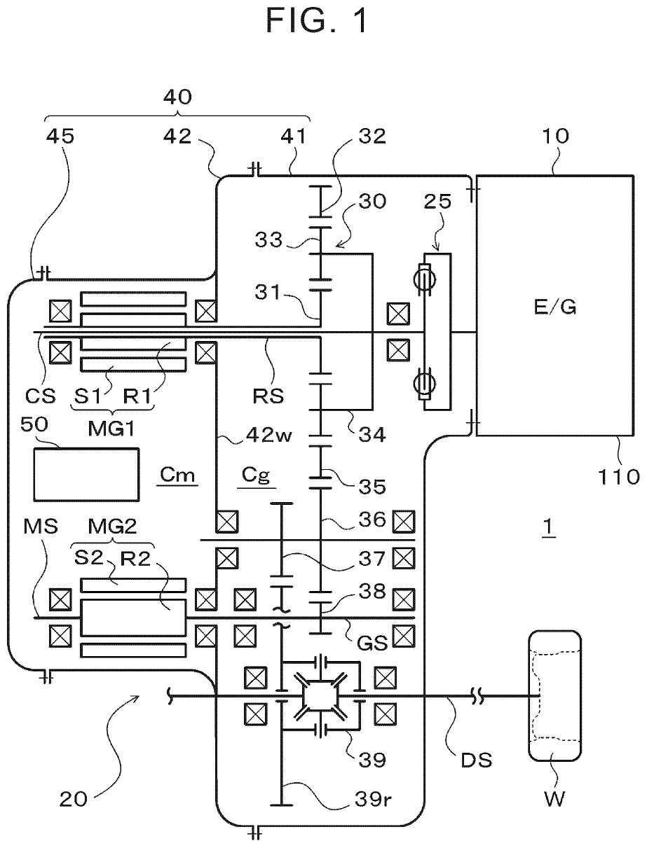

FIG. 1 is a schematic configuration diagram illustrating a vehicle 1 to which a mounting structure for an electrical device of the present disclosure is applied. Vehicle 1 shown in FIG. 1 is a front wheel drive type hybrid electric vehicle. The vehicle 1 includes an engine 10, a transaxle 20 as a power transmission device that includes a motor generator MG1 and a motor generator MG2 and is coupled to the engine 10, and a battery (not shown) that exchanges electric power with a motor generator MG1 and a motor generator MG2 of the transaxle 20 via an inverter (not shown) or the like. The engine 10 is an internal combustion engine that combusts an air-fuel mixture of hydrocarbon-based fuel and air injected from an injector (not shown) in a plurality of combustion chambers, and converts reciprocating motion of a piston caused by combustion of the air-fuel mixture into rotational motion of a crankshaft.

The transaxle 20 includes, in addition to the motor generator MG1 and the motor generator MG2, a planetary gear 30, a differential gear 39, and a case 40 that houses these elements, as shown in FIG. 1. The motor generator MG1 (first electric motor) is a synchronous generator motor (three-phase AC electric motor) including a stator S1 and a rotor R1, and operates as a generator that converts at least a portion of power from the engine 10, which is mainly loaded, into electric power. The motor generator MG2 (second electric motor) is a synchronous generator motor (three-phase AC electric motor) including a stator S2 and a rotor R2. The motor generator MG2 (second electric motor) is mainly operated as an electric motor driven by electric power from at least one of the battery and the motor generator MG1 to generate driving torque.

The planetary gear 30 is a differential rotation mechanism including a sun gear (first rotation element) 31, a ring gear (second rotation element) 32, and a planetary carrier (third rotation element) 34 that rotatably supports a plurality of pinion gears 33. As shown in FIG. 1, the sun gear 31 is connected to the rotor R1 of the motor generator MG1 via a hollow-rotor shaft RS. The planetary carrier 34 is coaxially fixed to the carrier shaft CS and is connected to the crankshaft of the engine 10 via the carrier shaft CS and the damper arrangement 25. The ring gear 32 is integrated with a counter drive gear 35 as an output member, and both of them rotate coaxially and integrally.

The counter drive gear 35 is connected to the left and right wheels (drive wheels) W via a counter driven gear 36 that meshes with the counter drive gear 35, a drive pinion gear (final drive gear) 37 that rotates integrally with the counter driven gear 36, a differential ring gear 39r that meshes with the drive pinion gear 37 and rotates integrally with a differential case of the differential gear 39, a differential gear 39, and a drive shaft DS. The gear mechanism of the transaxle 20 connects the engine 10 and the motor generator MG1 to each other, and transmits a part of the output torque of the engine 10 as a power generation source to the drive shaft DS and the wheels W. The gear mechanism of the transaxle 20 is, in other words, a gear train from the planetary gear 30 and the counter drive gear 35 to the differential gear 39.

Further, the drive gear 38 is connected (fixed) to the rotor R2 of the motor generator MG2 so as to rotate integrally with each other via the motor shaft MS. The drive gear 38 has a smaller number of teeth than the counter driven gear 36 and meshes with the counter driven gear 36. Accordingly, the motor generator MG2 is connected to the left and right drive shafts DS and the wheels W via the drive gear 38, the counter driven gear 36, the drive pinion gear 37, the differential ring gear 39r, and the differential gear 39. That is, the motor generator MG2 functions as a power generation source for outputting a driving torque (driving force) to the drive shaft DS and the wheels W alone or in cooperation with the engine 10, and outputs a regenerative braking torque at the time of braking of the vehicle 1.

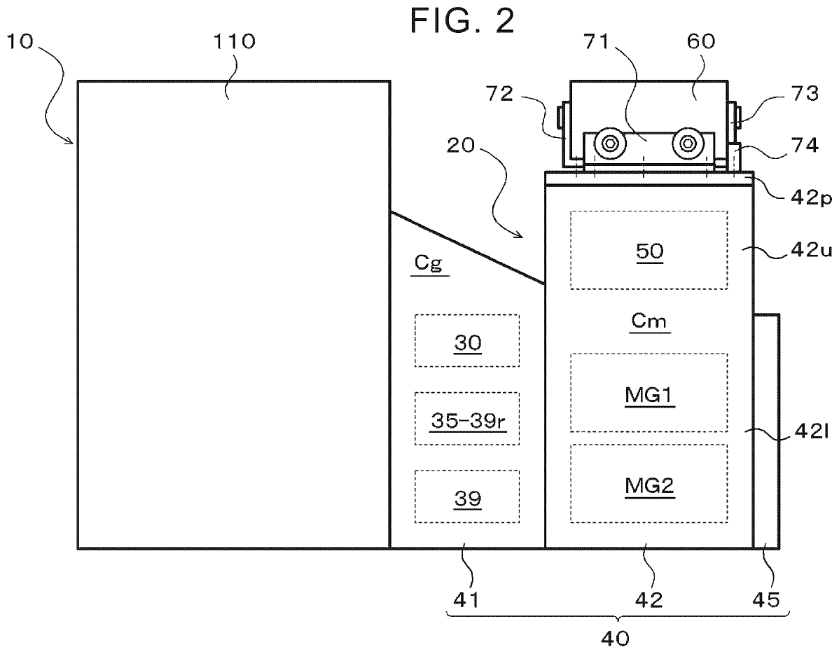

The case 40 of the transaxle 20 includes a first case 41, a second case 42, and a cover (third case) 45. Each of the first case 41, the second case 42 and the cover 45 is a cast product formed of, for example, an aluminum alloy or a steel material. The first case 41 is fastened (coupled) to the engine block (cylinder block) 110 of the engine 10 via a plurality of bolts so as to be adjacent to each other in the width direction of the vehicle 1, as shown in FIGS. 1 and 2. The second case 42 is fastened (coupled) to the first case 41 via a plurality of bolts so as to be adjacent to each other in the width direction of the vehicle 1, and constitutes a case body together with the first case 41. The cover 45 is fastened (coupled) to the second case 42 via a plurality of bolts so as to cover the open end of the second case 42 opposite to the first case 41 side.

Also. The second case 42 has a partition wall 42w that divides the inside of the case 40 (case body) into two parts (see FIG. 1). As a result, in the case 40, a gear chamber Cg is defined on the engine-10 side of the partition wall 42w, and a motor chamber Cm is defined on the cover 45 side of the partition wall 42w. As shown in FIGS. 1 and 2, gear trains from the planetary gear 30 and the counter drive gear 35 to the differential gear 39 are arranged in the gear chamber Cg. In the motor chamber Cm, as shown in FIGS. 1 and 2, a motor generator MG1, MG2 and a power control device (hereinafter, referred to as “PCU”) 50 connected to the motor generator MG1, MG2 and the battery are arranged.

PCU 50 includes a first inverter, a second inverter, a step-up converter, a filter capacitor, a smoothing capacitor, a DC/DC converter, an electronic control unit, and the like. The first inverter drives the motor generator MG1 and the second inverter drives the motor generator MG2. The step-up converter boosts the power from the battery and lowers the power from the motor generator MG1, MG2. DC/DC converter is connected to a power line connecting the battery and the step-up converter, an auxiliary battery, and a plurality of auxiliary devices, and supplies the electric power of the battery and the step-up converter to the auxiliary device battery and the auxiliary device by stepping down the electric power to the target voltage. The electronic control unit includes a microcomputer, various driving circuits, and the like, and controls the first and second inverters and the step-up converter. PCU 50 is disposed in the upper portion 42u of the second case 42 so as to be positioned above the motor generator MG1 and MG housed in the lower portion 421 of the second case 42. In the present embodiment, PCU 50 is attached to the core plate 42p covering the upper opening of the second case 42.

Further, the vehicle 1 includes a charger (AC charger) 60 which is an electrical device for charging a battery (not shown) by electric power from an AC power source outside the vehicle such as a household power source. The charger 60 includes an AC/DC converter that converts AC power into DC power, a DC/DC converter that boosts DC power outputted from AC/DC converter, a charge control device (neither of which is shown) that controls these electrical devices, a case 61 that houses these components, and a cover 62 that is fixed to the case 61. The case 61 of the charger 60 is attached (fixed) to the core plate 42p of the second case 42 (the case 40) via the first bracket (the first support member) 71, the second bracket (the second support member) 72, and the third bracket 73 (the third support member), as shown in FIG. 2.

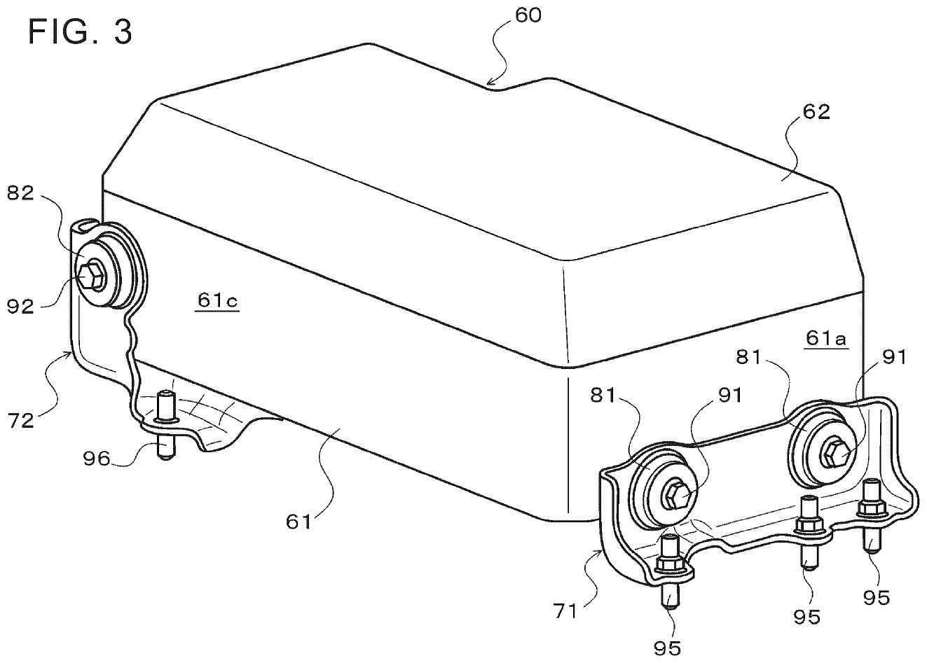

As shown in FIG. 3, the first brackets 71 are fastened to one end face 61a (end wall) of the case 61 of the charger 60 in the longitudinal direction via a plurality (in the present embodiment, two) of first anti-vibration bushes (first bushes) 81 and a plurality (in the present embodiment, two) of first bolts 91. In the present embodiment, there are two first anti-vibration bushes (first bushes) 81 and two first bolts 91. The first brackets 71 are made of, for example, metallic material, and have a plurality of (in the present embodiment, two) through holes (not shown) formed so as to be aligned in the width direction of the case 61 (end face 61a). Each of the first anti-vibration bushes 81 is formed in a hollow shape by an elastic body such as rubber, and is press-fitted into a corresponding through hole of the first bracket 71. Each of the first bolts 91 is inserted into the hollow portion of the corresponding first anti-vibration bush 81, and is screwed into a screw hole formed in the case 61 (end wall). Further, a part of the first anti-vibration bushes 81 abuts on the end face 61a of the case 61. Thus, the contraction direction of each first anti-vibration bush 81 and the extension direction of each first bolt 91 are parallel to the longitudinal direction of the case 61. Further, the first brackets 71 are fixed to the case 40 of the transaxle 20, that is, the core plate 42p of the second case 42, via a plurality of bolts 95 extending vertically.

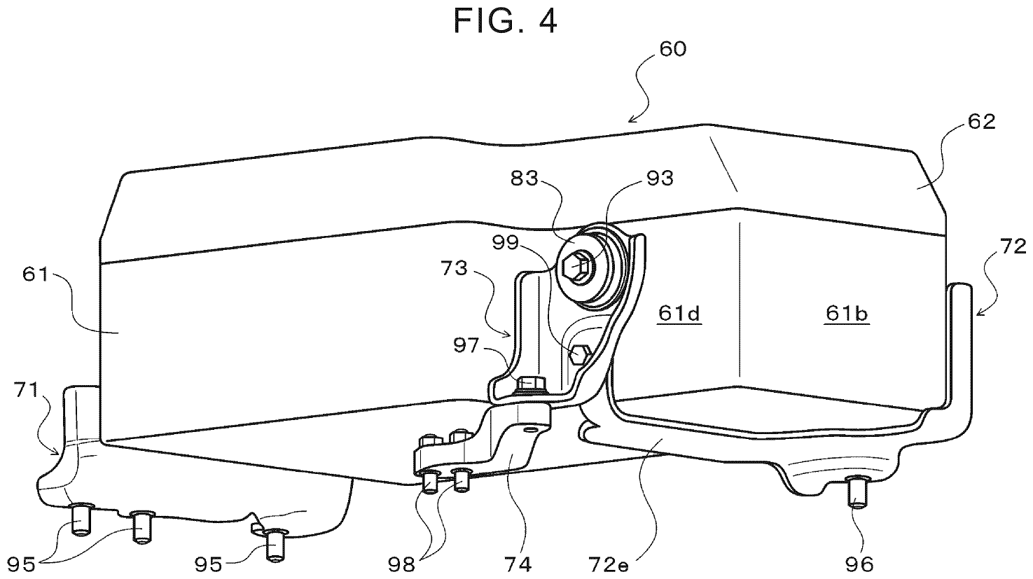

As shown in FIG. 3, the second brackets 72 are fastened to one (in this example, side surface 61c) of a pair of side surfaces 61c, 61d (side walls) of the case 61 extending longitudinally from one end face 61a of the case 11 toward the other end face 61b (see FIG. 4). Further, the second brackets 72 are fastened via a single second anti-vibration bush (second bush) 82 and a single second bolt 92 so as to be close to the other end face 61b. The second bracket 72 is made of, for example, metal, and has a single through-hole (not shown). The second anti-vibration bush 82 is formed in a hollow shape by an elastic body such as rubber, and is press-fitted into a through hole of the second bracket 72. The second bolt 92 is inserted into the hollow portion of the second anti-vibration bush 82 and is screwed into a screw hole formed in the case 61 (side wall). A part of the second anti-vibration bush 82 abuts against the side surface 61c of the case 61. Thus, the contraction direction of the second anti-vibration bush 82 and the extension direction of the second bolt 92 are parallel to the width direction (the direction orthogonal to the longitudinal direction) of the case 61. Further, the second brackets 72 are secured to the core plate 42p of the second case 42 via a single bolt 96.

As shown in FIG. 4, the third brackets 73 are fastened to the other (in this case, the side surface 61d) of the pair of side surfaces 61c, 61d (side walls) of the case 61 via a single third anti-vibration bush (third bush) 83 and a single third bolt 93 so as to be close to the other end face 61b. The third bracket 73 is made of, for example, metal, and has a single through-hole (not shown). The third anti-vibration bush 83 is formed in a hollow shape by an elastic body such as rubber, and is press-fitted into the through hole of the third bracket 73. The third bolt 93 is inserted into the hollow portion of the third anti-vibration bush 83 and is screwed into a screw hole formed in the case 61 (side wall). A part of the third anti-vibration bush 83 abuts against the side surface 61d of the case 61. Thus, the contraction direction of the third anti-vibration bush 83 and the extension direction of the third bolt 93 are parallel to the width direction (the direction orthogonal to the longitudinal direction) of the case 61.

Further, the third bracket 73 is coupled (fixed) to the fixing member 74 via a single or a plurality of bolts 97. The fixing member 74 is fixed to the core plate 42p of the second case 42 via the plurality of bolts 98, and thereby the third bracket 73 is fixed (coupled) to the core plate 42p. However, a portion corresponding to the fixing member 74 may be integrated with the third bracket 73. Further, in the present embodiment, the second bracket 72 includes an extension portion 72e extending from the side surface 61c side to the side surface 61d side, and the extension portion 72e is fixed to the third bracket 73 via a single bolt 99. Accordingly, the second and third brackets 72 and 73 are integrally connected to each other. However, the extension portion 72e may be omitted from the second bracket 72, and the extension portion may be formed in the third bracket 73.

As described above, the mounting structure for the charger 60 as an electrical device in the vehicle 1 includes the first bracket 71, the second bracket 72, and the third bracket 73. The first brackets 71 are fastened to one end face 61a of the case 61 of the charger 60 in the longitudinal direction through the plurality of first anti-vibration bushes 81 and the plurality of first bolts 91. At the same time, the first brackets 71 are fixed to the case 40 (core plate 42p) of the transaxle 20 as the target device. The second brackets 72 are fastened to one side surface 61c of the case 61 (charger 60) extending longitudinally from the end face 61a via the second anti-vibration bush 82 and the second bolt 92, and are fixed to the case 40 (core plate 42p). The third brackets 73 are fastened to the other side surface 61d of the case 61 of the charger 60 via the third anti-vibration bush 83 and the third bolt 93, and are fixed to the case 40 (core plate 42p).

As a result, the contraction direction of the plurality of first anti-vibration bushes 81 and the contraction directions of the second and third anti-vibration bushes 82 and 83 can be substantially orthogonal (crossed). Therefore, it is possible to prevent the resonance magnification of the first, second, and third anti-vibration bushes 81, 82, and 83 from increasing in a specific frequency range. As a result, in the vehicle 1, the vibration of the charger 60 attached to the transaxle 20 (the case 40) as the target device that is the source of the vibration can be satisfactorily reduced.

Further, in the vehicle 1, the second brackets 72 are fastened to one side surface 61c of the case 61 via the single second anti-vibration bush 82 and the single second bolt 92. Further, in the vehicle 1, the third bracket 73 is fastened to the other side surface 61d of the case 61 via the single third anti-vibration bush 83 and the single third bolt 93. The second and third brackets 72 and 73 are connected to each other via bolts 99. Accordingly, since the second and third brackets 72 and 73 are mutually constrained, the movement of the second and third brackets 72 and 73 caused by the vibration of the transaxle 20 (the case 40) can be restricted, and the looseness of the second bolt 92 and the third bolt 93 can be suppressed satisfactorily.

Note that the target device to which the charger 60 is attached is not limited to the transaxle 20 (case 40). For example, if PCU 50 is attached to the second case 42 outside the case 40 of the transaxle 20, the charger 60 may be attached to PCU 50. In addition, the electrical device attached to the target device serving as the vibration source is not limited to the charger 60, and may be, for example, a PCU 50 attached to the case 40 of the transaxle 20 serving as the target device.

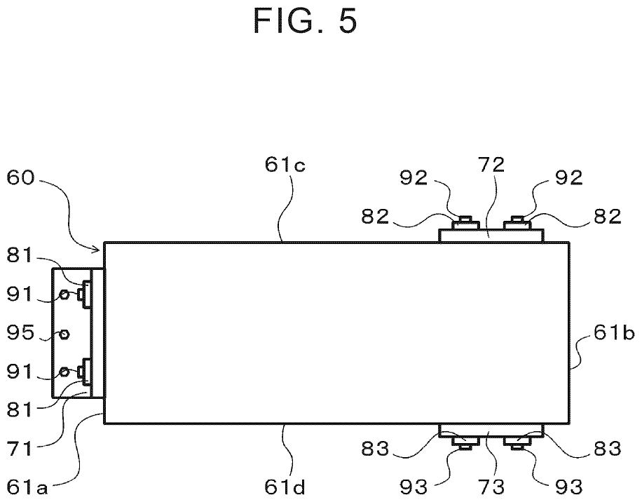

Further, as shown in FIG. 5, the second brackets 72 may be fastened to one side surface 61c (side wall) of the case 61 via a plurality (e.g., two) of second anti-vibration bushes 82 and a plurality (e.g., two) of second bolts 92. The third brackets 73 may be fastened to the other side surface 61d (side wall) of the case 61 via a plurality (for example, two) of the third anti-vibration bushes 83 and a plurality (for example, two) of the third bolts 93. In the example of FIG. 5, the second bracket 72 and the third bracket 73 are not connected to each other.

In the mounting structure shown in FIG. 5, when the case 40 of the transaxle 20 as the target device vibrates, it is possible to restrict the movement of the second bracket 72 with respect to the charger 60 (case 61) by the plurality of second bolts 92 and to restrict the movement of the third bracket 73 with respect to the charger 60 (case 61) by the plurality of third bolts 93. Thus, even if the second and third brackets 72 and 73 are not connected to each other, it is possible to satisfactorily suppress the loosening of the second bolt 92 and the third bolt 93.

It is needless to say that the disclosure of the present disclosure is not limited to the above-described embodiments, and various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The embodiments of the present disclosure can be used in the manufacturing industry of electrical devices etc.

What is claimed is:

1. A mounting structure for an electrical device that is configured to mount the electrical device to a target device that is a source of vibration, the mounting structure comprising:
a first support member that is fastened to one end face in a longitudinal direction of the electrical device via a plurality of first bushes and a plurality of first bolts and that is fixed to the target device;
a second support member that is fastened to one of a pair of side surfaces of the electrical device via a second bush and a second bolt and that is fixed to the target device, the side surfaces being surfaces extending in the longitudinal direction from the one end face; and
a third support member that is fastened to another of the side surfaces of the electrical device via a third bush and a third bolt and that is fixed to the target device.

2. The mounting structure according to claim 1, wherein:
the second support member is fastened to the one of the side surfaces via the second bush and the second bolt, the second bush being a single second bush, and the second bolt being a single second bolt;
the third support member is fastened to the other of the side surfaces via the third bush and the third bolt, the third bush being a single third bush, and the third bolt being a single third bolt; and
the second and third support members are connected to each other.

3. The mounting structure according to claim 1, wherein:
the second support member is fastened to the one of the side surfaces via a plurality of the second bushes and a plurality of the second bolts; and
the third support member is fastened to the other of the side surfaces via a plurality of the third bushes and a plurality of the third bolts.

4. The mounting structure according to claim 1, wherein:
the target device is either a transaxle mounted on a vehicle and including at least an electric motor or a different device attached to the transaxle; and
the electrical device is a charger that is used to charge a battery configured to transfer electric power to and from the electric motor.
